(19) United States
(12) Patent Application Publication
(10) Pub. No.: US 2019/0136613 A1
(43) Pub. Date: May 9, 2019

(54) RAIL FOR BLIND ASSEMBLY

(71) Applicant: Intigral, Inc., Walton Hills, OH (US)

(72) Inventors: Xuezhong ZHANG, Liaoning (CN); Donald SMITH, Marion, OH (US)

(21) Appl. No.: 16/307,296

(22) PCT Filed: Jun. 14, 2017
(86) PCT No.: PCT/US2017/037440

§ 371 Date: Dec. 5, 2018

Related U.S. Application Data
(60) Provisional application No. 62/349,947, filed on Jun. 14, 2016.

(51) Int. Cl. E06B 9/326; E06B 9/327

(52) U.S. Cl. CPC E06B 9/326; E06B 9/327

(57) ABSTRACT

The present disclosure provides for a blind assembly. The blind assembly includes a head rail, a bottom rail, and sun-blocking slots. Pull cords may connect the head rail to the bottom rail. The pull cords may allow the bottom rail to translate towards the head rail. The pull cords may include a first pull cord and a second pull cord. Each of the pull cords may be fed through apertures of the bottom rail. The pull cords may be tied together after feeding them through the bottom aperture. A user may adjust the bottom rail without having to alter the lengths or knots of the pull cords.

### RELATED APPLICATION DATA

This patent application claims priority to U.S. Provisional Patent Application No. 62/349,947 filed Jun. 14, 2016 and titled “Rail for Blind Assembly.” The complete text of this application is hereby incorporated by reference as though fully set forth herein in its entirety.

### FIELD OF THE INVENTION

The present invention relates to a blind, and more particularly to a rail for a blind assembly.

### BACKGROUND OF THE INVENTION

There is a growing international popularity for hollow blinds, due to their good thermal insulation, light transmittance and sun-shading properties. A hollow blind mainly consists of a set of sun-shading slats and a driven system which are sealed in hollow glasses. The driven system mainly includes both an upper belt gear and a lower belt gear. A belt is connected end to end by a drive handle and surrounds the two belt gears, wherein the upper belt gear is connected to a rope roller. The rope roller may rotate to change the position of the sun-shading slats, including moving the sun-shading slats up, down, open or closed.

In some blinds, blind cords are pulled downward to raise the slats; once the cords are let go upward, the slats go downward under the effect of gravity. In such a design, the strands of cords can become tangled, making the blinds inoperable or making the lower frame of the blinds tilt or skew to one side. In another aspect, if the blind cords are not pulled or released at the same rate or are not the appropriate length, the slats and lower frame may also tilt. This may not be desired because it may not be aesthetically pleasing, may not properly block or allow light, and may be generally undesirable.

### SUMMARY OF THE INVENTION

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

The present disclosure overcomes the deficiencies of the prior art and provides a blind assembly particularly useful for a hollow blind. This disclosure, more particularly, describes an apparatus, system, and method that allows for more efficient assembly of a blind and improved operation of the blind.

To solve the above problem and other problems, there is provided a blind apparatus for a hollow blind, comprising a head rail, a bottom rail comprising a first and a second aperture, one or more sun-blocking elements disposed between the head rail and the bottom rail, a first pull cord extending from the head rail to the bottom rail, and a portion of the first pull cord passing through the first aperture, and a second pull cord extending from the head rail to the bottom rail, and a portion of the second pull cord passing through the second aperture, wherein the portion of the first pull cord and the portion of the second pull cord are bound together.

According to the present invention, a method is additionally provided for a blind assembly, the method may include feeding a first pull cord through a first aperture of a bottom rail, feeding a second pull cord through a second aperture of the bottom rail, binding, at a connection point, a portion of the first pull cord that is fed through the first aperture to a portion of the second pull cord that is fed through the second aperture, and leveling the bottom rail by adjusting a relative position of the connection point.

The following description and the drawings disclose various illustrative aspects. Some improvements and novel aspects may be expressly identified, while others may be apparent from the description and drawings.

### BRIEF DESCRIPTION OF THE DRAWINGS

The present invention is further explained in conjunction with the accompanying drawings:

FIG. 1 is a front view of a traditional blind system;

FIG. 2 is a front and partial cross-sectional view of a blind apparatus in accordance with various disclosed aspects;

FIG. 3 is a bottom and partial cross-sectional view of a bottom rail for a blind apparatus in accordance with various disclosed aspects; and

FIG. 4 is a method for assembling a blind apparatus in accordance with various disclosed aspects.

### DETAILED DESCRIPTION

Reference will now be made to exemplary embodiments, examples of which are illustrated in the accompanying drawings. It is to be understood that other embodiments may be utilized, and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

While embodiments may generally refer to a hollow blind or hollow glass, it is noted that the teachings of the present disclosure may be utilized in other blind systems, such as non-hollow blinds where the blinds are exposed (e.g., not disposed between or within glass. It is further noted, that while embodiments may refer to a top, bottom, left, right, or the like, such labels are utilized for sake of brevity and clarity and do not limit the position or orientation of aspects disclosed herein. It is further noted that terms such as “cord,” “string,” “rope” or the like are used interchangeably unless context suggests otherwise or warrants a particular distinction among such terms. Moreover, a cord may comprise various materials, such as organic materials, synthetic materials, metals, plastics, or the like. Likewise, terms such as “slats,” “shades,” “panels,” or the like are used interchangeably unless context suggests otherwise or warrants a particular distinction among such terms. Slats, for instance, may comprise woods, plastics, metals, or other desired materials. Moreover, while embodiments refer to blind assemblies with slats, it is noted that other light or sun-blocking elements (e.g., cloth, etc.) may be utilized in accordance with the present disclosure.

It is noted that described blind assemblies may be disposed within hollow glass (e.g., between two panes of glass), utilized for non-hollow glass, or the like. In another aspect, embodiments may include various belt drives, belt tensioner devices, or the like. A belt tensioning device for a hollow blind may comprise one or more gears, motors, manual interfaces (e.g., cranks, buttons, etc.), and the like. In other examples, the blind assemblies may not include belt tensioner devices, and may use other mechanisms for raising and lowering the slats.

In some blinds, pull cords or strings are connected to a bottom slat or bottom rail of the blinds. These pull cords often include a right and a left pull cord. The length of each of these pull cords (e.g., length from a top rail to the bottom rail) determines the position of the bottom rail. For example, pulling on the pull cords raises the bottom rail. Allowing the pull cords to release allows the bottom rail to descend.

In general, each pull cord is connected to a position of the bottom rail. For example, the right pull cord is tied to or passed through a hole in the bottom rail. If passed through the bottom rail, the pull cord may be knotted under the hole. Likewise, the left pull cord is tied to pass through a different hole, and may also be knotted under the different hole. If these pull cords are not of an appropriate length, they must be adjusted. For instance, once the blind assembly is assembled, the bottom rail may be or appear uneven (e.g., not level). To make this level, the length of the right and left pull cords may be adjusted, the knots may be adjusted (e.g., adjusting the position of the knot), or the like. The process of adjusting the pull cords may be time-consuming. In some instances, the adjustment may take up to one half of the total assembly time.

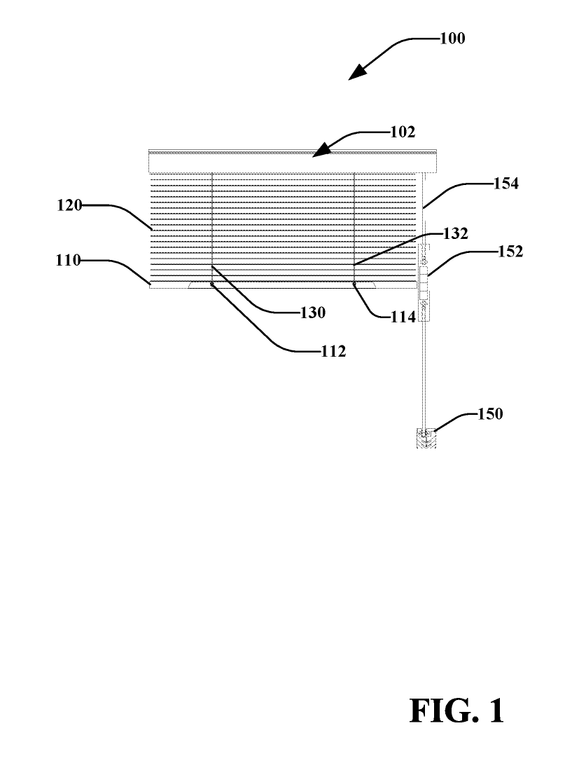

For instance, FIG. 1 depicts a blind assembly 100 that may be utilized with hollow glass. The blind assembly 100 may primarily include a head rail 102, a bottom rail 110, and one or more slats 120. A first pull cord 130 may extend from proximal the head rail 102 towards the bottom rail 110. The first pull cord 130 may pass through a first hole or aperture 112 of the bottom rail 110. In an aspect, the pull cord may be tied to the first aperture 112, knotted after being passed through the first aperture 112, tied to an anchor (e.g., bead, washer, etc.) that is below the aperture, or the like. Likewise, a second pull cord 132 may extend from proximal the head rail 102 towards the bottom rail 110. The second pull cord 132 may be affixed to or about a second aperture 114.

It is further noted that the bottom rail 110 may be raised and lowered via a belt tensioner device 150, magnetic operator 152, and belt 154, as described in more detail herein. It is noted that various other components or devices may be utilized to raise/lower or otherwise reposition the bottom rail 110 and/or slats 120.

As described above, the bottom rail 110 may be skewed, generally not level (e.g., with a horizon, windowpane, or the like), or otherwise in an undesired orientation. Adjusting of the level of the bottom rail 110 may involve changing the length of the first or second pull cord(s) 130/132, adjusting a knot, altering an anchor, or the like. Such adjustments may involve several different attempts to level the bottom rail 110. For instance, the blind assembly 100 may be assembled with the various operative components. After or as part of the assembly, a user may observe whether the bottom rail 110 is level. If the bottom rail is not level, the user may change the position of a knot on one of the first or second pull cords 130/132. Once the knot is adjusted, the user will observe the bottom rail 110 again to check to see if it is level. As can be the case, the user may repeat this process until a desired orientation is achieved. It is noted that this adjusting and leveling process may take a significant amount of time and may vary widely between blind assemblies.

Embodiments described herein may reduce this assembly time and may reduce assembly steps. In at least one exemplary embodiment, a blind assembly may include a top or head rail and a bottom rail. One or more sun-blocking elements may be disposed between the head rail and the bottom rail. Two or more pull cords may extend from the head rail to the bottom rail. For instance, the two or more pull cords may include a right and left pull cord. The right and left pull cords may be tied or otherwise coupled together. In an example, the bottom rail may include a first hole and a second hole. A first pull cord may pass through the first hole, and a second pull cord may pass through the second hole. The first pull cord and the second pull cord may be tied or otherwise coupled together. Being tied together may allow for adjustment of the bottom rail (e.g., leveling of the bottom rail) without adjusting a knot or the like.

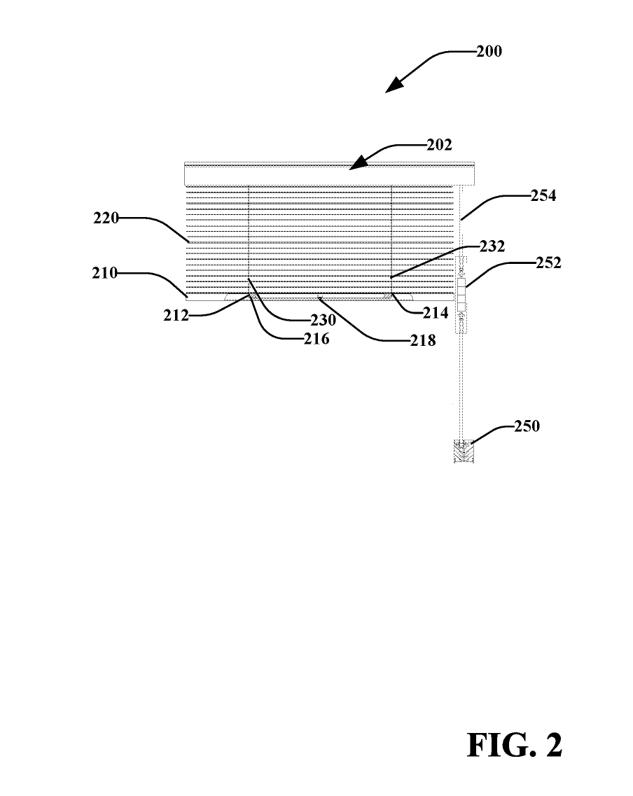

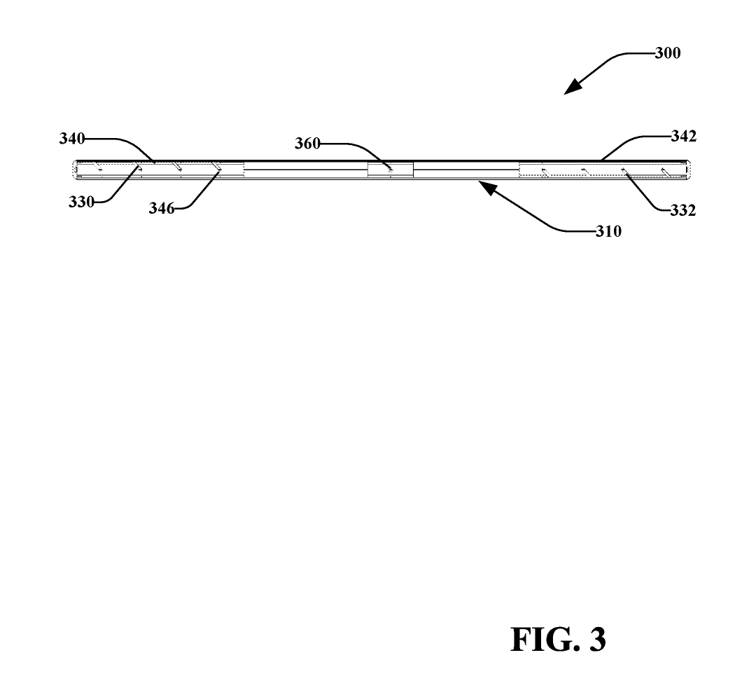

Turning now to FIG. 2, there is a blind assembly 200 in accordance with various disclosed aspects. As described, the blind assembly 200 may include a head rail 202, a bottom rail 210, and one or more sun-blocking elements or slats 220. One or more pull cords, such as first pull cord 230 and second pull cord 232, may extend from proximal head rail 202 towards bottom rail 210. It is noted that the first and second pull cords 230/232 may pass through the slats 220. In another aspect, while FIGS. 2 and 3 show two pull cords, any number of pull cords may be utilized. Moreover, it is noted that the bottom rail 210 may be raised and lowered via a belt tensioner device 250, magnetic operator 252, and belt 254, as described in more detail herein. It is noted that various other components or devices may be utilized to raise/lower or otherwise reposition the bottom rail 210 and/or slats 220.

The bottom rail 210 may include one or more apertures, such as first aperture 212 and second aperture 214. The first aperture 212 may receive the first pull cord 230, and the second aperture 214 may receive the second pull cord 232. In an aspect, the bottom rail 210 may include one or more blocks 216 (e.g., fulcrums) that may abut the first or second pull cords 230/232. It is noted that the blocks 216 may comprise a curved surface that may be smooth. This may reduce the chances of fraying or waring on the first or second pull cords 230/232.

In an aspect, the first and second pull cords 230/232 may be tied via a knot 218, or otherwise affixed together. For instance, the first and second pull cords 230/232 may be attached to or with a fastener (e.g., bracket, clip, etc.), adhered together (e.g., with an adhesive), or otherwise joined. This may allow the first and second pull cords 230/232 to translate through first and second apertures 212/214 while they are coupled together. For example, a user may pass the first pull cord 230 through the first aperture 212, and may pass the second pull cord 232 through the second aperture 214. The user may then tie the first cord 230 and the second pull cord 232 together. This may allow the level of the bottom rail 210 to be adjusted without requiring the user to adjust the knot or the length of the cords. In another aspect, the bottom rail 210 can automatically adjust to be level whenever the user raises the bottom rail 210 to a top position (e.g., to proximal the head rail 202).

It is noted that, once leveled, the first pull cord 230 and/or second pull cord 232 may be set at their respective positions. For instance, a user may fasten, adhere, tie, or otherwise fix the first pull cord 230 and/or second pull cord 232 to the bottom rail 210.

As shown in FIG. 3, a blind assembly 300 may include bottom rail 310. It is noted that the bottom rail 310 may be the same, similar, or a different bottom rail than bottom rail 210 of FIG. 2. Moreover, bottom rail 310 may comprise various other components or aspects within the scope and spirit of this disclosure.

Bottom rail 310 may receive a first pull cord 330 and a second pull cord 332. In an aspect, the bottom rail 310 may include a first end portion or end cap 340 (which may receive the first pull cord 330) and a second end cap 342 (which may receive the second pull cord 332). Each of the first and second pull end caps 340/342 may include one or more alignment formations, such as alignment slots 346. The first pull cord 330 and second pull cord 332, for example, may be fed through in or otherwise aligned with one or more of the alignment slots 346. These alignment slots 346 may generally prevent slippage of the first pull cord 330 and second pull cord 332 after the bottom rail 310 has been leveled. In another aspect, the alignment slots 346 may allow for alignment of the first pull cord 330 and second pull cord 332 such that they may be tied or joined together.

It is further noted that blind assembly 300 may include one or more other cords, such as a center cord (not shown) that may be fed through a center cap 360. The center cap 360 may comprise an aperture that receives the center cord. The center cord may be tied to the aperture, knotted below the aperture, or otherwise affixed to the center cap 360. This may allow aid in operation of the blind assembly 300.

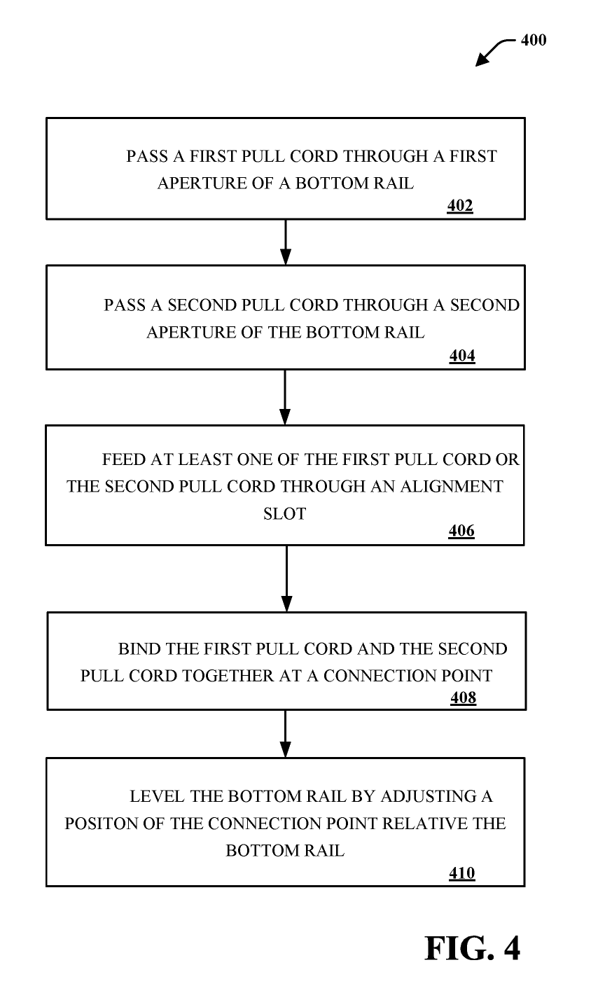

In view of the subject matter described herein, a method that may be related to various embodiments may be better appreciated with reference to the flowchart of FIG. 4. While method 400 is shown and described as a series of blocks, it is noted that associated method or process is not limited by the order of the blocks. It is further noted that some blocks and corresponding actions may occur in different orders or concurrently with other blocks. Moreover, different blocks or actions may be utilized to implement the method described hereinafter. Various actions may be completed by one or more of users, mechanical machines, automated assembly machines (e.g., including one or more processors or computing devices), or the like.

FIG. 4 depicts an exemplary flowchart of non-limiting method 400 associated with a blind apparatus, according to various aspects of the subject disclosure. At 402, a user may pass a first pull cord through a first aperture of a bottom rail. For instance, the user may thread or feed the first pull cord through one or more slats and through the aperture of the bottom rail. At 404, the user may pass a second pull cord through a second aperture of the bottom rail. At this point, both the first and second pull cords may be through apertures of the bottom rail, and the user may optionally proceed to reference numeral 406 or 408.

At 406, the user may feed at least one of the first pull cord or the second pull cord through an alignment slot, as shown in FIG. 3. It is noted that the bottom rail may include one or more alignment slots. It is further noted that one or more end caps of the bottom rail (e.g., which may be attachably connected to the bottom rail) may comprise the alignment slots. Feeding a pull cord through an alignment slot may include threading the pull cord through apertures, disposing the pull cord in grooves, or the like.

At 408, the user may bind the first pull cord and the second pull cord together at a connection point. As described herein, binding the first pull cord to the second pull cord may include tying, adhering, clipping or otherwise connect the first pull cord and the second pull cord. The connection point may comprise the knot, adhered position, clip, fastener, or the like. It is noted that the first and second pull cords may be bound by attaching each pull cord to a fastener or clip, as such the first and second pull cords need not physically touch each other.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A blind apparatus comprising:
a head rail;
a bottom rail comprising a first and a second aperture;
one or more sun-blocking elements disposed between the head rail and the bottom rail;
a first pull cord extending from the head rail to the bottom rail, and a portion of the first pull cord passing through the first aperture; and
a second pull cord extending from the head rail to the bottom rail, and a portion of the second pull cord passing through the second aperture,
wherein the portion of the first pull cord and the portion of the second pull cord are bound together.

2. The blind apparatus of claim 1, wherein the bottom rail further comprises a first block disposed proximal the first aperture and comprising a curved first service, wherein the portion of the first pull cord abuts the curved surface.

3. The blind apparatus of claim 2, wherein the bottom rail further comprises a second block disposed proximal the second aperture and comprising a second curved service, wherein the portion of the second pull cord abuts the curved surface.

4. The blind apparatus of claim 1, wherein the bottom rail comprises at least one alignment formation that receives the portion of the first pull cord.

5. The blind apparatus of claim 4, wherein the bottom rail comprises at least one other alignment formation that receives the portion of the second pull cord.

6. The blind apparatus of claim 1, wherein the portion of the first pull cord and the portion of the second pull cord are bound together with a knot.

7. The blind apparatus of claim 1, wherein the portion of the first pull cord and the portion of the second pull cord are bound together with an adhesive.

8. The blind apparatus of claim 1, wherein the portion of the first pull cord and the portion of the second pull cord are bound together with at least one of a clip or fastener.

9. The blind apparatus of claim 1, wherein the head rail, the bottom rail, the one or more sun-blocking elements, the first pull cord, and the second pull cord are disposed within hollow glass.

10. The blind apparatus of claim 1, further comprising a belt tensioning system that operatively alters a position of the bottom rail via the first and second pull cords.

11. The blind apparatus of claim 1, wherein the first and second pull cords operatively transpose the bottom rail to a top position proximal the head rail.

12. The blind apparatus of claim 11, wherein the bottom rail automatically levels when operatively transposed to the top position.

13. A method of assembling a blind apparatus comprising:
feeding a first pull cord through a first aperture of a bottom rail;
feeding a second pull cord through a second aperture of the bottom rail;
binding, at a connection point, a portion of the first pull cord that is fed through the first aperture to a portion of the second pull cord that is fed through the second aperture; and
leveling the bottom rail by adjusting a relative position of the connection point.

14. The method of claim 13, wherein leveling the bottom rail comprises transposing the bottom rail to a top position such that it is proximal a head rail.

15. The method of claim 13, wherein binding the portion of the first pull cord and the portion of the second pull cord comprises at least one of tying, clipping, or adhering the first portion of the first pull cord and the portion of the second pull cord.

16. The method of claim 13, further comprising feeding at least one of the first pull cord or the second pull cord through an alignment slot.

17. A blind apparatus comprising:
a head rail;
a bottom rail comprising a first and a second aperture;
one or more sun-blocking elements disposed between the head rail and the bottom rail;
a first pull cord extending from the head rail to the bottom rail, and a portion of the first pull cord passing through the first aperture;
a second pull cord extending from the head rail to the bottom rail, and a portion of the second pull cord passing through the second aperture;
a first block disposed proximal the first aperture and comprising a curved first service, wherein the portion of the first pull cord abuts the curved surface; and
a second block disposed proximal the second aperture and comprising a second curved service, wherein the portion of the second pull cord abuts the curved surface,
wherein the portion of the first pull cord and the portion of the second pull cord are bound together.

18. The blind apparatus of claim 17, wherein the bottom rail comprises at least one alignment formation that receives the portion of the first pull cord.

19. The blind apparatus of claim 18, wherein the bottom rail comprises at least one other alignment formation that receives the portion of the second pull cord.

20. The blind apparatus of claim 17, wherein the portion of the first pull cord and the portion of the second pull cord are bound together with a knot.

21. The blind apparatus of claim 17, wherein the portion of the first pull cord and the portion of the second pull cord are bound together with an adhesive.

22. The blind apparatus of claim 17, wherein the portion of the first pull cord and the portion of the second pull cord are bound together with at least one of a clip or fastener.

23. The blind apparatus of claim 17, wherein the head rail, the bottom rail, the one or more sun-blocking elements, the first pull cord, and the second pull cord are disposed within hollow glass.

24. The blind apparatus of claim 17, further comprising a belt tensioning system that operatively alters a position of the bottom rail via the first and second pull cords.

25. The blind apparatus of claim 17, wherein the first and second pull cords operatively transpose the bottom rail to a top position proximal the head rail.

26. The blind apparatus of claim 25, wherein the bottom rail automatically levels when operatively transposed to the top position.
